(19) United States
(12) Patent Application Publication
(10) Pub. No.: US 2014/0013143 A1
(43) Pub. Date: Jan. 9, 2014

(54) APPARATUS AND METHOD FOR PERFORMING USER AUTHENTICATION IN TERMINAL

(71) Applicant: Samsung Electronics Co. Ltd., Suwon-si (KR)

(72) Inventors: Sern-Young PARK, Suwon-si (KR); Jung-Won SUH, Uiwang-si (KR); Gye-Joong SHIN, Suwon-si (KR)

(21) Appl. No.: 13/935,975

(22) Filed: Jul. 5, 2013

(30) Foreign Application Priority Data
Jul. 6, 2012 (KR) 10-2012-0074021

(51) Int. Cl. G06F 1/32

(52) U.S. Cl. CPC G06F 1/3243
USPC 713/323

(57) ABSTRACT

A user authentication apparatus and method for allowing a user to conveniently perform user authentication by a touch and motion-based gesture in a terminal are provided. In the user authentication apparatus, a low-power sensor platform is configured to transfer a wake-up signal to a controller upon detecting a motion of the terminal for waking up while the terminal is in a sleep mode, and to transfer a motion signal generated while the terminal is in a wake-up mode to the controller. The controller is configured to switch the terminal to the wake-up mode in response to the wake-up signal that is received from the low-power sensor platform while the terminal is in the sleep mode, and to switch to a user-authenticated specific application mode upon receiving the motion signal from the low-power sensor platform during a touch occurring in a specific area while the terminal is in the wake-up mode.

### PRIORITY

This application claims the benefit under 35 U.S.C. §119(a) of a Korean patent application filed on Jul. 6, 2012 in the Korean Intellectual Property Office and assigned Serial No. 10-2012-0074021, the entire disclosure of which is incorporated herein by reference.

### BACKGROUND OF THE INVENTION

1. Field of the Invention

The present invention relates to an apparatus and method for performing user authentication in a terminal More particularly, the present invention relates to a user authentication apparatus and method for enabling a user to conveniently perform user authentication by a touch and motion-based gesture in a terminal.

2. Description of the Related Art

To use or enable a terminal, which is in a sleep mode where a screen is turned off, a user should switch the terminal to a wake-up mode by first inputting or pushing a Home key or a Power key and then entering a password or an unlock pattern to release a set lock screen.

In the wake-up mode, in order to run an application that requires user authentication such as login, the user should inconveniently enter his/her IDentifier (ID) and password one by one whenever he or she attempts to run the application.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a user authentication apparatus and method for allowing a user to conveniently perform user authentication by a touch and motion-based gesture in a terminal.

In accordance with an aspect of the present invention, an apparatus for performing user authentication in a terminal is provided. The apparatus includes a low-power sensor platform configured to transfer a wake-up signal to a controller upon detecting a motion of the terminal for waking up while the terminal is in a sleep mode, and to transfer a motion signal generated while the terminal is in a wake-up mode to the controller, and a controller configured to switch the terminal to the wake-up mode in response to the wake-up signal that is received from the low-power sensor platform while the terminal is in the sleep mode, and to switch to a user-authenticated specific application mode upon receiving the motion signal from the low-power sensor platform during a touch occurring in a specific area while the terminal is in the wake-up mode.

In accordance with another aspect of the present invention, a method for performing user authentication in a terminal is provided. The method includes switching the terminal to a wake-up mode upon detecting a motion of the terminal for waking up while the terminal is in a sleep mode, and switching to a user-authenticated specific application mode upon detecting a motion of the terminal during a touch occurring in a specific area while the terminal is in the wake-up mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 shows a structure of a terminal according to an exemplary embodiment of the present invention;

FIG. 2 shows a user authentication registration process for an application in a terminal according to an exemplary embodiment of the present invention;

FIGS. 3A and 3B are diagrams for a description of the process shown in FIG. 2 according to an exemplary embodiment of the present invention; and

FIG. 4 shows a process of performing user authentication on an application in a terminal according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terminals, to which exemplary embodiments of the present invention are applicable, may include mobile terminals and fixed terminals. The mobile terminals, which may be easy-to-carry mobile electronic devices, may include video phones, mobile phones, smart phones, International Mobile Telecommunication 2000 (IMT-2000) terminals, Wideband Code Division Multiple Access (WCDMA) terminals, Universal Mobile Telecommunication Service (UMTS) terminals, Personal Digital Assistants (PDAs), Portable Multimedia Players (PMPs), Digital Multimedia Broadcasting (DMB) terminals, e-Books, portable computers (e.g., laptop computers, tablet computers, etc.), digital cameras, etc. The fixed terminals may include desktop Personal Computers (PCs), and the like.

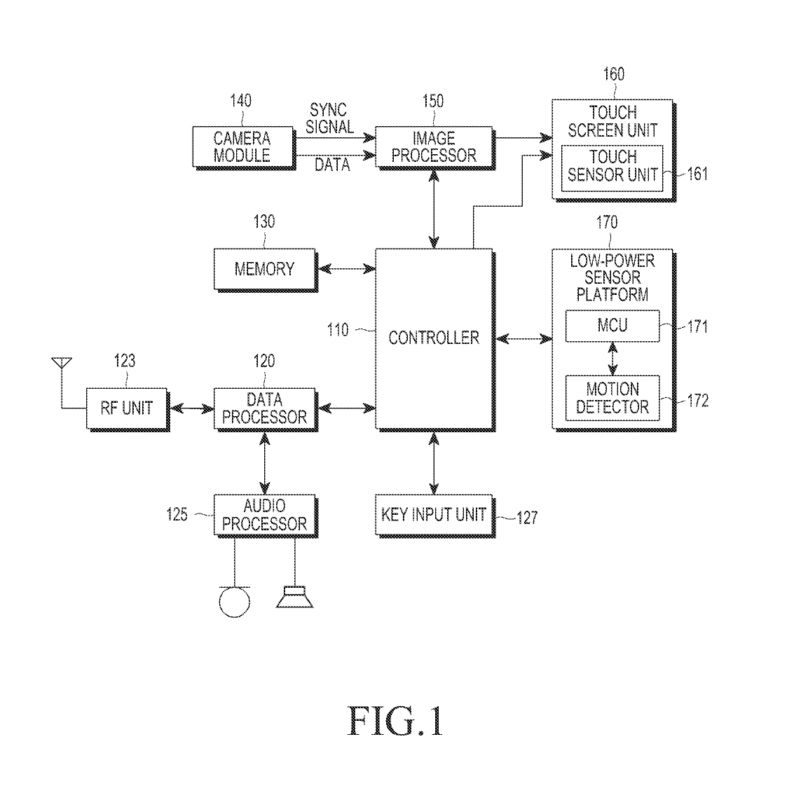

FIG. 1 shows a structure of a terminal according to an exemplary embodiment of the present invention.

Referring to FIG. 1, a Radio Frequency (RF) unit 123 is responsible for wireless communication of the terminal. The RF unit 123 includes an RF transmitter for up-converting a frequency of transmission signals and amplifying the up-converted transmission signals, and an RF receiver for low-noise-amplifying received signals and down-converting a frequency of the amplified received signals. A data processor 120 includes a transmitter for coding and modulating the transmission signals, and a receiver for demodulating and decoding the received signals. In other words, the data processor 120 may include a modulator/demodulator (modem) and a coder/decoder (codec). The codec may include a data codec for processing packet data and the like, and an audio codec for processing audio signals such as voice. An audio processor 125 plays received audio signals output from the audio codec in the data processor 120 using a speaker, and transfers audio signals picked up by a microphone to the audio codec in the data processor 120.

A key input unit 127 includes numeric/character keys for entering numeric/character information, and function keys for setting various functions.

A memory 130 may include a program memory and a data memory. The program memory may store programs for controlling the general operation of the terminal, and programs for allowing a user to perform user authentication by a touch and motion-based gesture in accordance with an exemplary embodiment of the present invention. The data memory may temporarily store the data generated during execution of the programs.

In accordance with an exemplary embodiment of the present invention, the memory 130 stores one or more applications registered in its associated area among a plurality of areas on a screen of a touch screen unit 160, and at least one password registered in the one or more applications. The at least one password registered in the one or more applications may include a first password for user authentication and mode switching for the application, and may include a second password for mode switching for the one or more applications. The at least one password registered in the one or more applications may be generated by a combination of a touch on an area in which the application is registered, and a terminal's motion signal.

A low-power sensor platform 170 transfers a wake-up signal to a controller 110 upon detecting a terminal's motion for waking up in a sleep mode, and transfers a terminal's motion signal generated in a wake-up mode to the controller 110. The low-power sensor platform 170 includes a Micro Controller Unit (MCU) 171 and a motion detector 172.

The MCU 171, which operates with low power, periodically wakes up from the sleep mode to check whether a motion signal is generated by the motion detector 172. Upon receiving a terminal's motion signal for waking up from the motion detector 172, the MCU 171 transfers a wake-up signal to the controller 110. The MCU 171 transfers a motion signal that is received from the motion detector 172 in the wake-up mode, to the controller 110.

The motion detector 172 detects a terminal's motion, detects a motion signal corresponding to the terminal's motion, and transfers the detected motion signal to the MCU 171.

The motion detector 172 may include at least one of an acceleration sensor, a gyro sensor, and a gesture sensor. In the sleep mode, only the acceleration sensor is enabled to detect the terminal's motion. In the wake-up mode, for accuracy, all of the acceleration sensor, the gyro sensor, and the gesture sensor are enabled to detect the terminal's motion.

The controller 110 controls the overall operation of the terminal.

In accordance with an exemplary embodiment of the present invention, the controller 110 switches the terminal to the wake-up mode in response to a wake-up signal that is received from the low-power sensor platform 170 in the sleep mode, and upon receiving a motion signal from the low-power sensor platform 170 during a touch (event) occurring in a specific area in the wake-up mode, the controller 110 switches to a user-authenticated specific application mode (e.g., a mode in which the specific application has passed user authentication).

The controller 110 may release a lock screen set in the terminal and switch to the wake-up mode, in response to a wake-up signal that is received from the low-power sensor platform 170 in the sleep mode.

The wake-up mode may include at least one of a standby mode and an arbitrary application mode.

Upon receiving a motion signal from the low-power sensor platform 170 during a touch occurring in a specific area on a screen in the wake-up mode, the controller 110 may determine whether a specific application is registered in the specific area (or the touched area) in which the touch has occurred. If a specific application is registered in the touched area, the controller 110 determines whether a password corresponding to a combination of coordinates of the touched area and the motion signal is identical to a first password that is registered in the specific application for user authentication and mode switching, and if they are identical, switches to the user-authenticated specific application mode.

Alternatively, the controller 110 determines whether a password corresponding to a combination of coordinates of the touched area and the motion signal is identical to a second password that is registered in the specific application for mode switching, and if they are identical, switches to the specific application mode (e.g., a mode in which the specific application has not passed user authentication or does not require user authentication).

The controller 110 registers a selected specific application in a selected specific area among a plurality of areas in a touch and motion-based application registration mode, and upon receiving a first motion signal from the low-power sensor platform 170 during a touch occurring in the selected specific area, the controller 110 combines coordinates of the touched area with the first motion signal, and registers the combination results as a first password for user authentication and mode switching for the specific application.

Alternatively, upon receiving a second motion signal from the low-power sensor platform 170 during a touch occurring in the selected specific area in the touch and motion-based application registration mode, the controller 110 combines coordinates of the touched area with the second motion signal, and registers the combination results as a second password for mode switching for the specific application.

The controller 110 controls to display a screen divided into a plurality of areas, in the touch and motion-based application registration mode, and the plurality of areas are set to display registration/non-registration of their associated applications. The controller 110 may change the application-registered areas depending on a user's gestures.

A camera module 140 includes a camera sensor for capturing image data and converting the captured optical image signals into electrical image signals, and a signal processor for converting analog image signals captured by the camera sensor into digital image data. The camera sensor may be a Charge-Coupled Device (CCD) sensor or a Complementary Metal-Oxide Semiconductor (CMOS) sensor, and the signal processor may be implemented using a Digital Signal Processor (DSP). The camera sensor and the signal processor may be implemented integrally or separately.

An image processor 150 performs Image Signal Processing (ISP) to display the image signals output from the camera module 140 on the touch screen unit 160. The ISP may include functions such as gamma correction, interpolation, spatial variation, image effects, image scaling, Auto White Balance (AWB), Auto Exposure (AE), and Auto Focus (AF). The image processor 150 processes the image signals output from the camera module 140 on a frame-by-frame basis, and outputs the frame image data according to the characteristics and size of the touch screen unit 160. The image processor 150, having a video codec, may compress frame image data displayed on the touch screen unit 160 using a set coding scheme, and decompresses compressed frame image data into its original frame image data using a set decoding scheme. The video codec may be any one of a Joint Photographic Experts Group (JPEG) codec, a Moving Picture Experts Group 4 (MPEG4) codec, Wavelet codec, etc. If the image processor 150 is assumed to have the On-Screen Display (OSD) feature, it may output OSD data according to the size of the displayed screen under control of the controller 110.

The touch screen unit 160 may serve as an input unit and a display unit. When serving as a display unit, the touch screen unit 160 displays, on a screen, image signals output from the image processor 150 and user data output from the controller 110. On the contrary, if the touch screen unit 160 serves as an input unit, the same keys as those on the key input unit 127 may be displayed on the touch screen unit 160. When serving as an input unit, the touch screen unit 160 includes a touch sensor unit 161 for detecting coordinate values which are received depending on user's touch actions, and transferring the detected coordinate values to the controller 110.

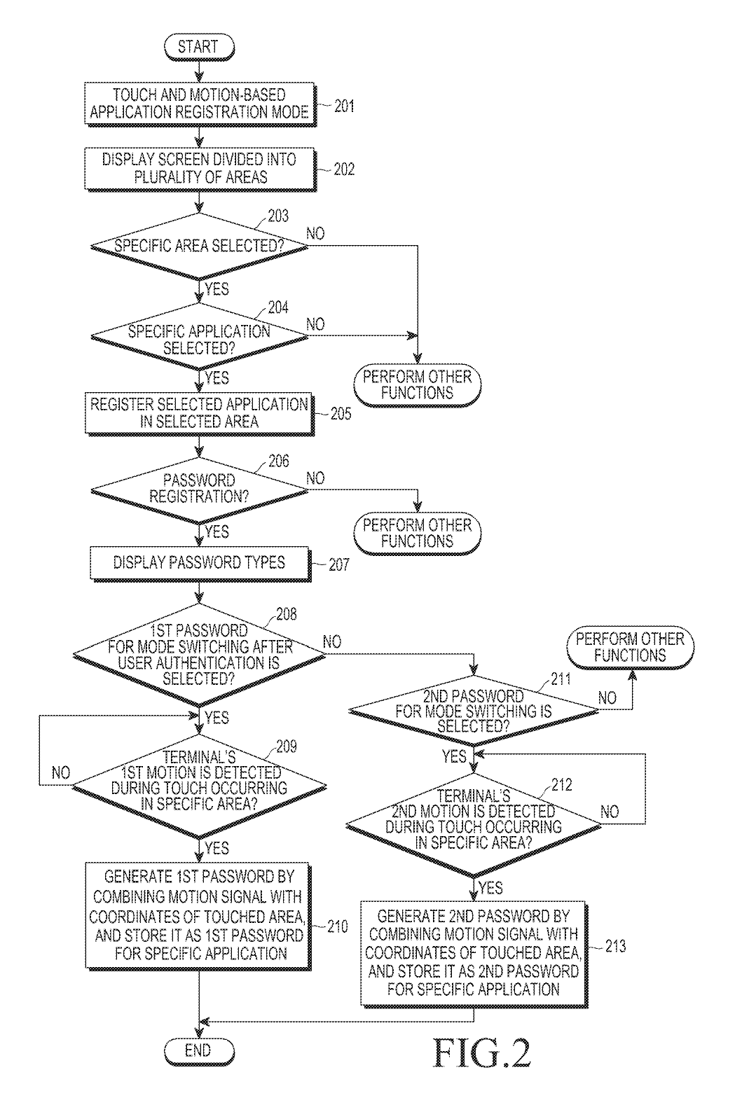

A mode switching control operation in the above-described terminal will be described in below with reference to FIGS. 2 to 4.

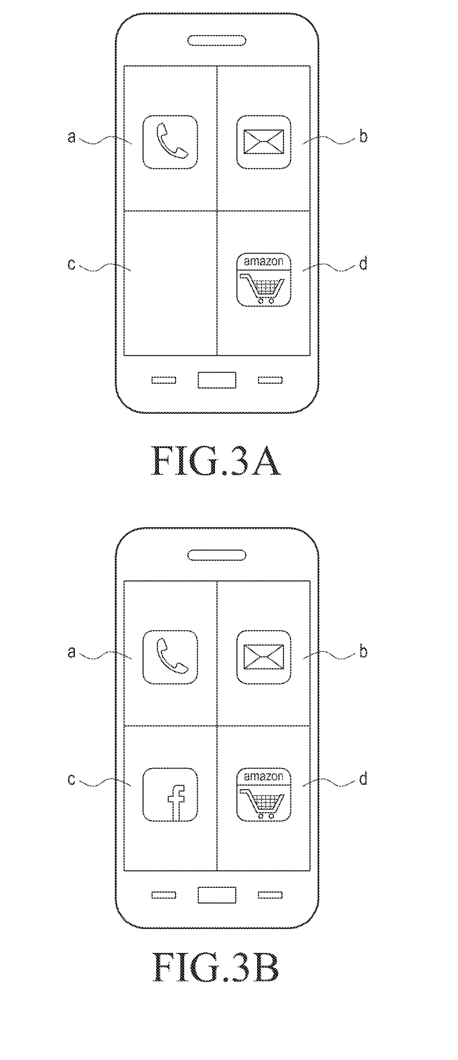

FIG. 2 shows a user authentication registration process for an application in a terminal according to an exemplary embodiment of the present invention. FIGS. 3A and 3B are diagrams for a description of the process shown in FIG. 2 according to an exemplary embodiment of the present invention.

The mode switching control operation provided by an exemplary embodiment of the present invention will be described in detail below with reference to FIG. 1.

Referring to FIG. 2, the controller 110, which is in the touch and motion-based application registration mode in step 201, controls to display a screen on the touch screen unit 160, which is divided into a plurality of areas, in step 202.

If a specific area is selected on the screen divided into the plurality of areas depending on a user's touch action in step 203, the controller 110 controls to display all applications stored in the terminal. If a specific application is selected from among the displayed applications in step 204, the controller 110 registers in step 205 the selected specific application as a specific application for the specific area selected in step 203. If ‘Password Registration’ for the specific application, which is registered in the specific area in step 205, is chosen by the user in step 206, the controller 110 controls to display the types of registerable passwords in step 207.

If ‘Registration’ of a first password for user authentication and mode switching is chosen by the user from among the displayed types of passwords in step 208, the controller 110 controls to display a message asking the user to touch the specific area in which the specific application is registered, and to move or shake the terminal

If a terminal's first motion signal is received in step 209 from the low-power sensor platform 170 during the touch occurring in the specific area in which the specific application is registered, the controller 110 generates a first password by combining coordinates of the specific area (or the touched area) in which the touch has occurred, with the received first motion signal, and stores the generated first password in the memory 130 as a first password for user authentication and mode switching for the specific application registered in the specific area, in step 210.

If ‘Registration’ of a second password for mode switching is chosen by the user from among the displayed types of passwords in step 211, the controller 110 controls to display a message asking the user to touch the specific area in which the specific application is registered, and to move or shake the terminal.

If a terminal's second motion signal is received in step 212 from the low-power sensor platform 170 during the touch occurring in the specific area in which the specific application is registered, the controller 110 generates a second password by combining coordinates of the specific area (or the touched area) in which the touch has occurred, with the received second motion signal, and stores the generated second password in the memory 130 as a second password for mode switching for the specific application registered in the specific area, in step 213.

The operation of FIG. 2 will be described below with reference to FIGS. 3A and 3B.

Referring to FIG. 3A, in the touch and motion-based application registration mode, the terminal may display a screen divided into a plurality of areas ‘a’ to ‘d’ Among the plurality of areas, the areas ‘a’, ‘b’ and ‘d’, in which their associated applications are registered, pertinent icons may be displayed to indicate that their associated applications are registered in their associated areas.

If the area ‘c’, in which no application is registered, and a Social Networking Service (SNS) application among a plurality of applications stored in the terminal are selected by the user, the controller 110 registers the SNS application in the area ‘c’. After ‘Registration’ of a first password for user authentication and mode switching for the SNS application is chosen by the user, if a first motion signal is generated as the user moves or shakes the terminal, for example, from side to side while the area ‘c’, in which the SNS application is registered, is touched by the user, the controller 110 combines coordinates of the area ‘c’ (or the touched area) in which the touch has occurred, with the first motion signal, and registers the combination results as a first password for user authentication and mode switching.

After ‘Registration’ of a second password for mode switching for the SNS application is chosen by the user, if a second motion signal is generated as the user moves or shakes the terminal, for example, up and down while the area ‘c’, in which the SNS application is registered, is touched by the user, the controller 110 combines coordinates of the area ‘c’ (or the touched area) in which the touch has occurred, with the second motion signal, and registers the combination results as a second password for mode switching.

Referring to FIG. 3B, the area ‘c’ in which an SNS application is registered is shown.

The user may delete a registered application from the area in which it is registered, or may change or shift the application-registered area by a specific gesture, e.g., a drag.

For example, in FIG. 3B, if a drag occurs from the area ‘c’ to the area ‘a’, an SNS application may be registered in the area ‘a’, and a call application may be registered in the area ‘c’.

Although the displayed screen is divided into four areas in FIGS. 3A and 3B, the areas may increase or decrease in number, or may be formed in various different shapes. The number and/or shapes of the areas may be user definable.

Although only the first password for user authentication and mode switching and the second password for mode switching have been described for a specific application in an exemplary embodiment of the present invention, various other passwords may be registered to directly perform other functions of the specific application.

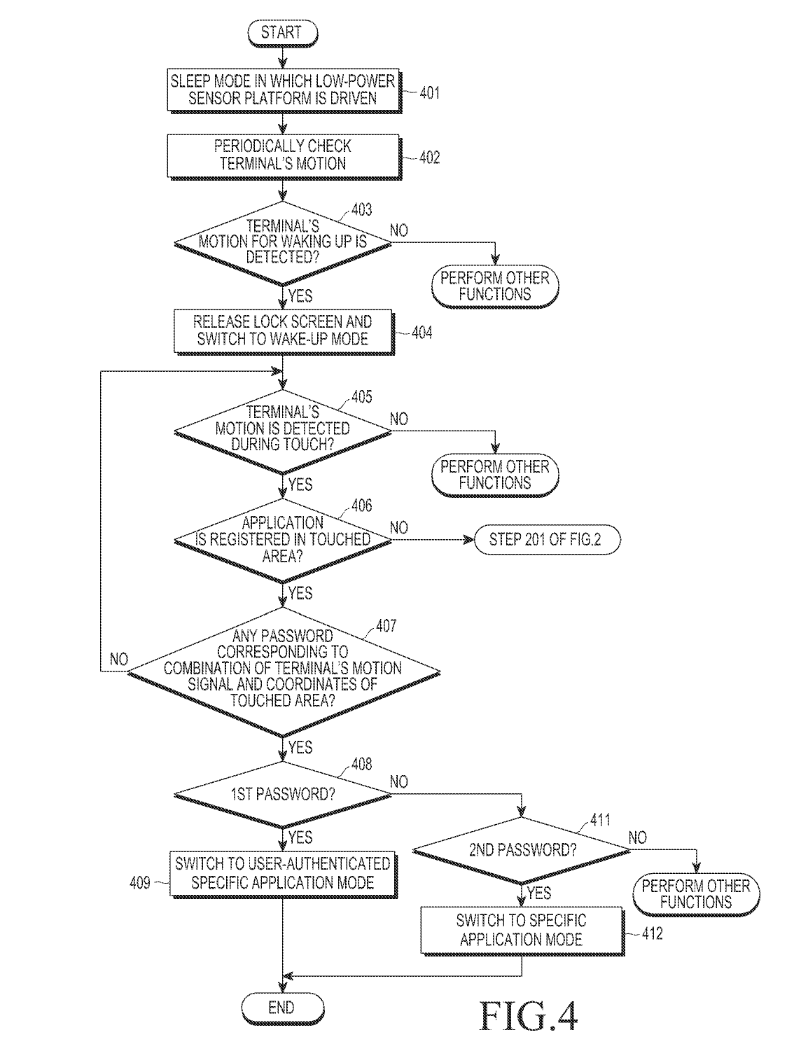

FIG. 4 shows a process of performing user authentication on an application in a terminal according to an exemplary embodiment of the present invention.

The process provided by an exemplary embodiment of the present invention will be described with reference to FIG. 1.

Referring to FIG. 4, the terminal, which is in the sleep mode in step 401 where its screen is turned off, drives the low-power sensor platform 170, and the low-power sensor platform 170 checks in step 402 whether the terminal's motion has occurred. Here, the low-power sensor platform 170 may periodically check whether the terminal's motion has occurred. Alternatively, the low-power sensor platform 170 may continually check whether the terminal's motion has occurred or the low-power sensor platform 170 may, upon a trigger, check whether the terminal's motion has occurred.

If the terminal's motion has occurred in step 402, the motion detector 172 in the low-power sensor platform 170 transfers a motion signal corresponding to the terminal's motion to the MCU 171 in the low-power sensor platform 170. The MCU 171 wakes up to determine whether a motion signal is received from the motion detector 172. Here, the MCU 171 may periodically wake up to determine whether a motion signal is received from the motion detector 172. Alternatively, the MCU 171 may continually wake up to determine whether a motion signal is received from the motion detector 172.

If the motion signal received from the motion detector 172 is detected as a motion signal for using or enabling the terminal, e.g., a motion signal for waking up in step 403, the MCU 171 releases a lock screen if the lock screen is set in the terminal, and then directly switches to the wake-up mode, in step 404.

Thus, the user may conveniently perform both user authentication and mode switching by a terminal's motion(s) pre-set by the user, without the hassle of releasing a lock screen after inputting or pushing a Home key or a Power key to switch the terminal from the sleep mode to the wake-up mode.

If a motion signal is received from the low-power sensor platform 170 during a touch which occurs in a specific area on a screen in the wake-up mode in step 405, the controller 110 determines in step 406 whether a specific application is registered in the specific area (or the touched area) in which the touch has occurred.

As for the motion signal from the low-power sensor platform 170, the motion detector 172 detects the terminal's motion and transfers its associated motion signals to the MCU 171, and the MCU 171 transfers the motion signal received from the motion detector 172 to the controller 110.

If the specific application is registered in the touched area in step 406, the controller 110 determines in step 407 whether a password corresponding to a combination of coordinates of the touched area and the received motion signal exists in the memory 130 as a password of the specific application registered in the specific area.

If the password corresponding to the combination exists as a first password for the specific application registered in the specific area in step 408, the controller 110 switches to a user-authenticated specific application mode in step 409.

Thus, the user may conveniently perform both user authentication and mode switching on the specific application by moving or shaking the terminal while touching the specific area.

If the password corresponding to the combination exists as a second password for the specific application registered in the specific area in step 411, the controller 110 switches to the specific application mode without user authentication in step 412.

However, if the specific application is not registered in the touched area in step 406, the controller 110 may switch to the touch and motion-based application registration mode of FIG. 2 depending on the user's choice. Here, the controller 110 may proceed to step 201 of FIG. 2.

The wake-up mode may include at least one of a standby mode and an arbitrary application mode. Therefore, the user may perform both user authentication and mode switching to his/her desired application mode by moving or shaking the terminal while touching the specific area not only in the standby mode but also in the arbitrary application mode.

For example, if a first motion signal is received as the user moves or shakes the terminal from side to side while touching the specific area corresponding to the area ‘c’ in FIG. 3B, not only in the standby mode but also on the screen displaying any running application, then the controller 110 may directly switch to the SNS application mode after automatically performing, or completing user authentication or login thereon, i.e., may directly switch to the user-authenticated SNS application mode.

Alternatively, if a second motion signal is received as the user moves or shakes the terminal up and down while touching the specific area on the screen, which corresponds to the area ‘c’ in FIG. 3B, then the controller 110 may switch to the user-unauthenticated SNS application mode and display on the screen a message asking for user authentication.

A method provided by exemplary embodiments of the present invention may register a combination of a touch occurring in a specific area and a terminal's motion as a password, making it possible to conveniently perform user authentication and mode switching on a specific application.

The proposed method may register as a password not only a combination of a touch occurring in a specific area and a terminal's motion occurring during the touch, but also a combination of a specific shape that a user entered on a screen, and a terminal's motion signal that is generated within a predetermined time.

For example, assuming that an action of moving or shaking the terminal from side to side after entering a circular shape on a screen is registered as a first password for user authentication and mode switching for an SNS application, the terminal may switch to a user-authenticated SNS application mode if it detects a terminal's left/right motion within a predetermined time after a circular shape is entered on the screen in the wake-up mode.

Also, assuming that an action of moving or shaking the terminal up and down after entering a circular shape on a screen is registered as a second password for mode switching for an SNS application, the terminal may switch to an SNS application mode if it detects a terminal's up/down motion within a predetermined time after a circular shape is entered on the screen in the wake-up mode.

Various different shapes may be entered on the screen depending on user settings.

The user authentication apparatus and method provided by exemplary embodiments of the present invention may be implemented in a non-transitory computer-readable recording medium with computer-readable codes. The non-transitory computer-readable recording medium may include all kinds of non-transitory recording devices in which computer-readable data may be stored. Examples of the non-transitory recording medium may include Read-Only Memory (ROM), Random Access Memory (RAM), optical disks, magnetic tapes, floppy disks, hard disks, and nonvolatile memories. The non-transitory computer-readable recording medium may be distributed over the computer systems connected by the network so that computer-readable codes may be stored and executed in a distributed manner.

As is apparent from the foregoing description, the user authentication apparatus and method provided by exemplary embodiments of the present invention may increase the encryption level, and may allow a user to conveniently perform user authentication without directly entering individual IDentifiers (IDs) and passwords for various services or applications.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for performing user authentication in a terminal, the apparatus comprising:
a low-power sensor platform configured to transfer a wake-up signal to a controller upon detecting a motion of the terminal for waking up while the terminal is in a sleep mode, and to transfer a motion signal generated while the terminal is in a wake-up mode to the controller; and
a controller configured to switch the terminal to the wake-up mode in response to the wake-up signal that is received from the low-power sensor platform while the terminal is in the sleep mode, and to switch to a user-authenticated specific application mode upon receiving the motion signal from the low-power sensor platform during a touch occurring in a specific area while the terminal is in the wake-up mode.

2. The apparatus of claim 1, wherein the low-power sensor platform comprises:
a Micro Controller Unit (MCU) configured to periodically wake up from the sleep mode to check whether a motion signal is generated by a motion detector, to transfer the wake-up signal to the controller upon receiving a motion signal for waking up from the motion detector, and to transfer to the controller the motion signal that is received from the motion detector while the terminal is in the wake-up mode; and
the motion detector configured to detect a motion signal corresponding to a motion of the terminal, and to transfer the detected motion signal to the MCU.

3. The apparatus of claim 2, wherein the motion detector includes at least one of an acceleration sensor, a gyro sensor, and a gesture sensor.

4. The apparatus of claim 1, wherein the wake-up mode includes at least one of a standby mode and an arbitrary application mode.

5. The apparatus of claim 1, wherein the controller is configured to release a lock screen set in the terminal and switch to the wake-up mode, in response to the wake-up signal that is received from the low-power sensor platform while the terminal is in the sleep mode.

6. The apparatus of claim 1, wherein, when the motion signal is received from the low-power sensor platform during the touch occurring in the specific area on a screen while the terminal is in the wake-up mode, if a specific application is registered in the specific area where the touch occurs, and a password corresponding to a combination of coordinates of the touch occurring in the specific area and the motion signal is identical to a first password that is registered in the specific application for user authentication and mode switching, the controller is configured to switch to a user-authenticated specific application mode.

7. The apparatus of claim 6, wherein the controller is configured to switch to a specific application mode, if a password corresponding to a combination of coordinates of the touch occurring in the specific area and the motion signal is identical to a second password that is registered in the specific application for mode switching.

8. The apparatus of claim 1, wherein the controller is configured to register a selected specific application in a selected specific area among a plurality of areas in a touch and motion-based application registration mode, and when a first motion signal is received from the low-power sensor platform during the touch occurring in the selected specific area, the controller is configured to combine coordinates of the specific area in which the touch occurs, with the first motion signal, and to register the combination results as a first password for user authentication and mode switching for the specific application.

9. The apparatus of claim 8, wherein, when a second motion signal is received from the low-power sensor platform during the touch occurring in the selected specific area, the controller is configured to combine coordinates of the specific area in which the touch occurs, with the second motion signal, and to register the combination results as a second password for mode switching for the specific application.

10. The apparatus of claim 8, wherein, in the touch and motion-based application registration mode, the controller is configured to control to display a screen divided into a plurality of areas and to change an application-registered area depending on a gesture, the plurality of areas being displayed to indicate whether associated applications are registered.

11. A method for performing user authentication in a terminal, the method comprising:
switching the terminal to a wake-up mode upon detecting a motion of the terminal for waking up while the terminal is in a sleep mode; and
switching to a user-authenticated specific application mode upon detecting a motion of the terminal during a touch occurring in a specific area while the terminal is in the wake-up mode.

12. The method of claim 11, wherein the switching to the wake-up mode comprises:
periodically waking up, by a low-power sensor platform, from the sleep mode to check whether a motion of the terminal is detected;
upon detecting the motion of the terminal, determining whether the motion of the terminal is the motion of the terminal for waking up; and
if the motion of the terminal is a motion of the terminal for waking up, transferring a wake-up signal to a controller to switch the terminal to the wake-up mode.

13. The method of claim 11, wherein the switching to the wake-up mode comprises, upon detecting the motion of the terminal for waking up, releasing a lock screen set in the terminal and switching to the wake-up mode.

14. The method of claim 11, wherein the wake-up mode includes at least one of a standby mode and an arbitrary application mode.

15. The method of claim 11, wherein the switching to the user-authenticated specific application mode comprises:
upon detecting the motion of the terminal during the touch occurring in the specific area on a screen while the terminal is in the wake-up mode, determining whether a specific application is registered in the specific area in which the touch occurs;
if a specific application is registered in the specific area in which the touch occurs, extracting a password corresponding to a combination of coordinates of the touch occurring in the specific area and a motion signal corresponding to the motion of the terminal; and
switching to a user-authenticated specific application mode, if the password corresponding to the combination of the coordinates of the touch occurring in the specific area and the motion signal is identical to a first password which is registered in the specific application for user authentication and mode switching.

16. The method of claim 15, further comprising switching to a specific application mode, if the password corresponding to the combination of the coordinates of the touch occurring in the specific area and the motion signal is identical to a second password which is registered in the specific application for mode switching.

17. The method of claim 11, further comprising:
displaying a screen divided into a plurality of areas, in a touch and motion-based application registration mode;
registering a selected specific application in a selected specific area among the plurality of areas; and
if a first motion signal is generated depending on the motion of the terminal during the touch occurring in the selected specific area, combining coordinates of the specific area in which the touch occurs, with the first motion signal, and registering the combination results as a first password for user authentication and mode switching for the specific application.

18. The method of claim 17, further comprising:
if a second motion signal is generated depending on the motion of the terminal during the touch occurring in the selected specific area, combining coordinates of the specific area in which the touch occurs, with the second motion signal, and registering the combination results as a second password for mode switching for the specific application.

19. The method of claim 17, wherein, in the touch and motion-based application registration mode, the displaying comprises displaying the screen divided into the plurality of areas and changing an application-registered area depending on a gesture, the plurality of areas being displayed to indicate whether associated applications are registered.

20. A non-transitory processor-readable recording medium storing a program for performing the method of claim 11.
